(19) United States
(12) Patent Application Publication
(10) Pub. No.: US 2019/0220885 A1
(43) Pub. Date: Jul. 18, 2019

(54) METHOD FOR PROVIDING ADVERTISEMENT SERVICE

(71) Applicant: Jae Woo KIM, Yonqin-si (KR)

(72) Inventor: Jae Woo KIM, Yonqin-si (KR)

(21) Appl. No.: 16/162,542

(22) Filed: Oct. 17, 2018

(30) Foreign Application Priority Data
Jan. 18, 2018 (KR) 10-2018-0006575

(51) Int. Cl. G06Q 30/02; G06T 19/00

(52) U.S. Cl. CPC G06Q 30/0236; G06Q 30/0267; G06T 19/006; G06Q 30/0239; G06Q 30/0257

(57) ABSTRACT

According to an embodiment, a method comprises receiving a request for virtual content corresponding to a product for advertisement from a first scanning terminal capturing the product, providing the virtual content to the first scanning terminal, counting a second scanning terminal as a first accrued terminal when the second scanning terminal captures the virtual content displayed on the first scanning terminal, when a third terminal capturing a screen of the second scanning terminal forms a branch to stretch to a lower node in a binary tree, counting a level corresponding to a depth of the node, and when the level reaches a preset number, providing preset reward to any one of the first scanning terminal, the second scanning terminal, and the third terminal.

### CROSS-REFERENCE TO RELATED APPLICATIONS

This patent application claims priority under 35 U.S.C. § 119 to Korean Patent Application No. 10-2018-0006575, filed on Jan. 18, 2018, in the Korean Intellectual Property Office, the disclosure of which is incorporated by reference herein in its entirety.

### TECHNICAL FIELD

Embodiments of the disclosure relate to advertisement serving methods and systems, and more specifically, to advertisement serving methods and systems that may display virtual content on the screen for advertisement purposes and that may provide a reward when an accrued scan count reaches a preset number, using virtual content in an AR and VR environment.

### DISCUSSION OF RELATED ART

Augmented reality (AR) technology is currently in wide use on mobile devices for, e.g., marketing or advertisement purposes. Augmented Reality (AR) is an interactive experience of a real-world environment whereby the objects that reside in the real-world are “augmented” by computer-generated perceptual information, sometimes across multiple sensory modalities, including visual, auditory, haptic, somatosensory, and olfactory.

Meanwhile, ongoing efforts have been made for efficient advertisement utilizing media and digital technology, but they fail to present satisfactory results due to customers' avoidance.

Thus, a need exists for applying AR techniques to the marketing or advertising sector.

### SUMMARY

According to an embodiment, a method for providing an advertisement service to provide a reward depending on an accrued scan count using virtual content in an augmented reality (AR) and virtual reality (VR) environment may be executed on an advertisement serving server. The method comprises receiving a request for virtual content corresponding to a product for advertisement from a first scanning terminal capturing the product, providing the virtual content to the first scanning terminal, counting a second scanning terminal as a first accrued terminal when the second scanning terminal captures the virtual content displayed on the first scanning terminal, when a third terminal capturing a screen of the second scanning terminal forms a branch to stretch to a lower node in a binary tree, counting a level corresponding to a depth of the node, and when the level reaches a preset number, providing preset reward to any one of the first scanning terminal, the second scanning terminal, and the third terminal.

A pre-stored identifier configured to identify the first scanning terminal may be created and output as an icon.

The method may further comprise, after providing the preset reward, providing user information about a plurality of scanning terminals constituting nodes of the binary tree up to the preset number of level to a social media account of the first scanning terminal.

The method may further comprise, after providing the preset reward, driving a camera of the first scanning terminal to capture an image when the first scanning terminal uses the reward and streaming the captured image to a plurality of scanning terminals constituting nodes of the binary tree up to the preset number.

The virtual content may include VR content or AR content.

Counting the second scanning terminal as the first accrued terminal when the second scanning terminal captures the virtual content displayed on the first scanning terminal may include creating a swipe pattern corresponding to a gesture of sending the displayed virtual content in a direction from the first scanning terminal to the second scanning terminal, detecting a position of the swipe pattern on the first scanning terminal and the direction of the swipe pattern, and providing an image of movement of the virtual content to the second scanning terminal, and wherein a moving speed, moving direction, and moving angle of the virtual content on screen are controlled corresponding to a speed, direction, and angle of the swipe pattern.

Counting the second scanning terminal as the first accrued terminal when the second scanning terminal captures the virtual content displayed on the first scanning terminal may include displaying a number of the first accrued terminal, which is 1, on the first scanning terminal, and wherein when the third terminal forms the branch to stretch to the lower node in the binary tree, the number of the first accrued terminal is varied in real-time to increase.

When the third terminal forms the branch to stretch to the lower node in the binary tree, the number corresponding to the node level may be varied in real-time to the first scanning terminal, the second scanning terminal, and a terminal positioned at the lower node.

The virtual content may include a plurality of locked items. As terminals capturing the first scanning terminal or the second scanning terminal increase in number, the plurality of locked items may be unlocked and displayed in a preset order.

There is provided a storage medium storing an application configured to execute the method.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

A more complete appreciation of the disclosure and many of the attendant aspects thereof will be readily obtained as the same becomes better understood by reference to the following detailed description when considered in connection with the accompanying drawings, wherein:

FIG. 1 is a view illustrating an advertisement serving system provides a reward depending on an accrued scan count using virtual content in an AR and VR environment, according to an embodiment;

FIG. 2 is a block diagram illustrating a configuration of an advertisement serving server included in the advertisement serving system of FIG. 1;

FIGS. 3A, 3B, 3C, 3D, 3E, and 3F are views illustrating an advertisement service that provides a reward depending on an accrued scan count using virtual content in an AR and VR environment according to an embodiment;

FIG. 4 is a view illustrating a process for transmitting and receiving data among components of an advertisement serving system as illustrated in FIG. 1, according to an embodiment; and

FIG. 5 is a flowchart illustrating an advertisement serving method that provides a reward depending on an accrued scan count using virtual content in an AR and VR environment, according to an embodiment.

### DETAILED DESCRIPTION OF EXEMPLARY EMBODIMENTS

Hereinafter, exemplary embodiments of the inventive concept will be described in detail with reference to the accompanying drawings. Like reference denotations may be used to refer to the same or substantially the same elements throughout the drawings and the specification. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

Hereinafter, exemplary embodiments of the inventive concept will be described in detail with reference to the accompanying drawings. The inventive concept, however, may be modified in various different ways, and should not be construed as limited to the embodiments set forth herein. Like reference denotations may be used to refer to the same or similar elements throughout the specification and the drawings.

However, the disclosure may be implemented in other various forms and is not limited to the embodiments set forth herein.

For clarity of the disclosure, irrelevant parts are removed from the drawings, and similar reference denotations are used to refer to similar elements throughout the specification.

In embodiments of the disclosure, when an element is “connected” with another element, the element may be “directly connected” with the other element, or the element may be “electrically connected” with the other element via an intervening element.

When an element “comprises” or “includes” another element, the element may further include, but rather than excluding, the other element, and the terms “comprise” and “include” should be appreciated as not excluding the possibility of presence or adding one or more features, numbers, steps, operations, elements, parts, or combinations thereof.

When the measurement of an element is modified by the term “about” or “substantially,” if a production or material tolerance is provided for the element, the term “about” or “substantially” is used to indicate that the element has the same or a close value to the measurement and is used for a better understanding of the disclosure or for preventing any unscrupulous infringement of the disclosure where the exact or absolute numbers are mentioned.

As used herein, “step of” A or “step A-ing” does not necessarily mean that the step is one for A.

As used herein, the term “part” may mean a unit or device implemented in hardware, software, or a combination thereof.

One unit may be implemented with two or more hardware devices or components, or two or more units may be implemented in a single hardware device or component.

As used herein, some of the operations or functions described to be performed by a terminal or device may be, instead of the terminal or device, performed by a server connected with the terminal or device.

Likewise, some of the operations or functions described to be performed by a server may be performed by a terminal or device connected with the server, instead of the server.

As used herein, some of the operations or functions described to be mapped or matched with a terminal may be interpreted as mapping or matching the unique number of the terminal, which is identification information about the terminal, or personal identification information.

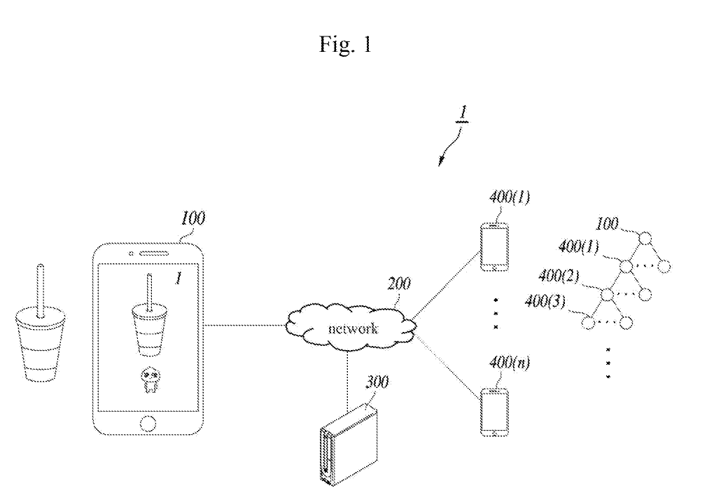

FIG. 1 is a view illustrating an advertisement serving system provides a reward depending on an accrued scan count using virtual content in an AR and VR environment, according to an embodiment.

Referring to FIG. 1, an advertisement serving system 1, according to an embodiment, may include a first scanning terminal 100, an advertisement serving server 300, a second scanning terminal 400(1), and an Nth scanning terminal 400(n). The advertisement serving system 1 may provide a reward depending on an accrued scan count using virtual content in an augmented reality (AR) and virtual reality (VR) environment.

However, it should be noted that the advertisement serving system 1 of FIG. 1 is merely an embodiment of the disclosure and is not limited thereto or thereby.

The components of the advertisement serving system 1 may be connected together via a network 200. For example, the first scanning terminal 100 may be connected with the advertisement serving server 300 via the network 200. The advertisement serving server 300 may be connected with the first scanning terminal 100, the second scanning terminal 400(1), and the Nth scanning terminal 400(n) via the network 200. The second scanning terminal 400(1) may be connected with the advertisement serving server 300, the first scanning terminal 100, and the Nth scanning terminal 400(n) via the network 200. The Nth scanning terminal 400(n) may be connected with the first scanning terminal 100, the advertisement serving server 300, and the second scanning terminal 400(1) via the network 200.

The term “network” as used herein refers to a connection architecture enabling exchange of information among multiple nodes, e.g., terminals and servers, and examples of the network may include, but be not limited to, radio frequency (RF) networks, 3rd generation partnership project (3GPP) networks, long term evolution (LTE) networks, 5th generation partnership project (5GPP) networks, world interoperability for microwave access (WIMAX) networks, Internet, local area network (LAN), wireless LAN, wide area network, personal area network (PAN), Bluetooth networks, near-field communication (NFC) networks, satellite broadcast networks, analog broadcast networks, and digital multimedia broadcasting (DMB) networks.

The first scanning terminal 100 may be an electronic device or terminal that may capture, scan, or read products using an advertisement service-related webpage, app page, program, or application that provides a reward depending on an accrued scan count using virtual content in an AR and VR environment. The first scanning terminal 100 may receive virtual content, which have previously been mapped to products and stored, from the advertisement serving server 300 and may output the virtual content.

The first scanning terminal 100 may display at least one item included in the virtual content, which is not output because it is in a locked state but can be unlocked depending on the scan count of the second scanning terminal 400(1) and the Nth scanning terminal 400(n).

Where there are a plurality of second scanning terminals 400(1), the first scanning terminal 100 may count and output the number of the second scanning terminals 400(1) on the screen. Where the number of second scanning terminals 400(1) reaches a preset number, the first scanning terminal 100 may receive a reward from the advertisement serving server 300.

The first scanning terminal 100 may receive profiles of the second scanning terminal 400(1) through the Nth scanning terminal 400(n) using a social media account of the first scanning terminal 100.

The first scanning terminal 100 may be implemented as a computer that is able to access to a remote server or terminal via a network. Examples of the computer may include navigation devices, web browser-equipped laptop computers, and desktop computers.

The first scanning terminal 100 may be implemented to be able to access a remote server or terminal via a network.

Examples of the first scanning terminal 100 may be portable, mobile wireless communication devices, including, but not limited to, navigation devices, personal communication systems (PCSs), global system for mobile communications (GSM), personal digital cellular (PDC), personal handyphone system (PHS), personal digital assistants (PDA), international mobile telecommunication (IMT)-2000, code division multiple access (CDMA)-2000, wideband CDMA (WCDMA), wireless broadband internet (Wibro) terminals, smartphones, smartpads, tablet PCs, or other various handheld wireless communication devices.

The advertisement serving server 300 may be a server that may provide an advertisement service webpage, app page, program, or application to provide a reward depending on an accrued scan count using virtual content in an AR and VR environment.

Where the first scanning terminal 100 captures, scans, or reads a product, the advertisement serving server 300 may provide virtual content, which has previously been mapped to the product and stored, to the first scanning terminal 100, may create a binary tree having the first scanning terminal 100 as a parent node depending on the number of the first scanning terminal 100 through the Nth scanning terminal 400(n) which capture or receive the screen of the first scanning terminal 100, and may increase the number of items in the virtual content which is unlocked on the first scanning terminal 100 as the number of terminals scanned increases or the number of branches scanned increases.

As the number of branches increases, the advertisement serving server 300 may provide the number of the branches to the first scanning terminal 100 to inform the first scanning terminal 100 how many nodes or branches can be built up to the reward.

When the first scanning terminal 100 receives a reward, the advertisement serving server 300 may capture the user of the first scanning terminal 100, who exchanges the reward with a product, and may, in real-time, provide the captured image to the second scanning terminal 400(1) through the Nth scanning terminal 400(n).

The advertisement serving server 300 may provide profiles of the second scanning terminal 400(1) through the Nth scanning terminal 400(n) using a social media account of the first scanning terminal 100.

The advertisement serving server 300 may be implemented as a computer able to access a remote server or terminal via a network. Examples of the computer may include, e.g., navigation devices, web browser-equipped laptop computers, and desktop computers.

The second scanning terminal 400(1) may be a terminal of a user who uses an advertisement service-related webpage, app page, program, or application to provide a reward depending on an accrued scan count using virtual content in an AR and VR environment.

The second scanning terminal 400(1) may scan or capture the screen of the first scanning terminal 100 and output the same screen as the screen of the first scanning terminal 100.

Where the Nth scanning terminal 400(n) scans the screen of the second scanning terminal 400(1), the second scanning terminal 400(1) may be a reference terminal that builds up as many lower nodes and branches of a binary tree as the number of the scans. Other functions or operations of the second scanning terminal 400(1) may be substantially the same as those of the first scanning terminal 100.

The second scanning terminal 400(1) may be implemented as a computer that is able to access to a remote server or terminal via a network. Examples of the computer may include navigation devices, web browser-equipped laptop computers, and desktop computers.

The second scanning terminal 400(1) may be implemented to be able to access a remote server or terminal via a network.

Examples of the second scanning terminal 400(1) may be portable, mobile wireless communication devices, including, but not limited to, navigation devices, personal communication systems (PCSs), global system for mobile communications (GSM), personal digital cellular (PDC), personal handyphone system (PHS), personal digital assistants (PDA), international mobile telecommunication (IMT)-2000, code division multiple access (CDMA)-2000, wideband CDMA (WCDMA), wireless broadband internet (Wibro) terminals, smartphones, smartpads, tablet PCs, or other various handheld wireless communication devices.

The Nth scanning terminal 400(n) may have the same or substantially the same functions or operations as those of the first scanning terminal 100 or the second scanning terminal 400(1). For example, the Nth scanning terminal 400(n) may provide the same functions as those of the first scanning terminal 100 or the second scanning terminal 400(1) except that the Nth scanning terminal 400(n) is located at a node or branch lower than the first scanning terminal 100 and the second scanning terminal 400(1) and may build up its lower nodes or branches from the Nth scanning terminal 400(n).

The Nth scanning terminal 400(n) may be implemented as a computer that is able to access to a remote server or terminal via a network. Examples of the computer may include navigation devices, web browser-equipped laptop computers, and desktop computers.

The Nth scanning terminal 400(n) may be implemented to be able to access a remote server or terminal via a network.

Examples of the Nth scanning terminal 400(n) may be portable, mobile wireless communication devices, including, but not limited to, navigation devices, personal communication systems (PCSs), global system for mobile communications (GSM), personal digital cellular (PDC), personal handyphone system (PHS), personal digital assistants (PDA), international mobile telecommunication (IMT)-2000, code division multiple access (CDMA)-2000, wideband CDMA (WCDMA), wireless broadband internet (Wibro) terminals, smartphones, smartpads, tablet PCs, or other various handheld wireless communication devices.

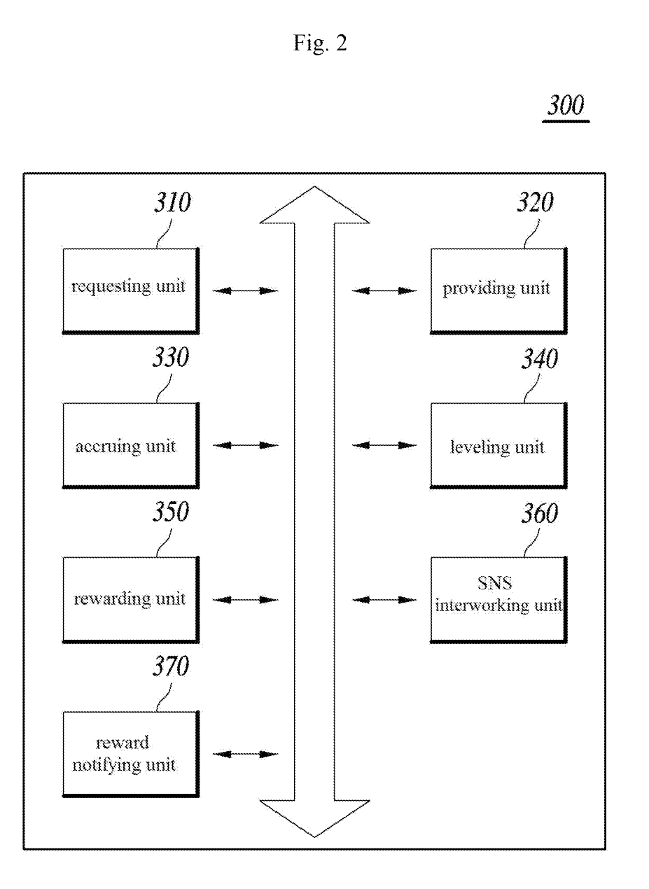

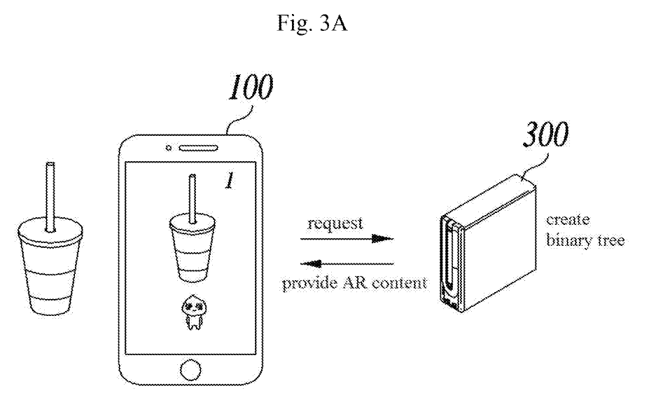

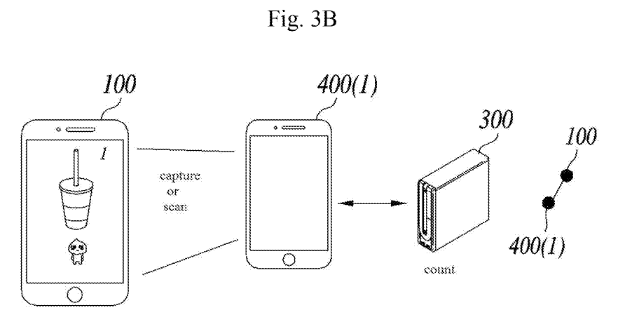

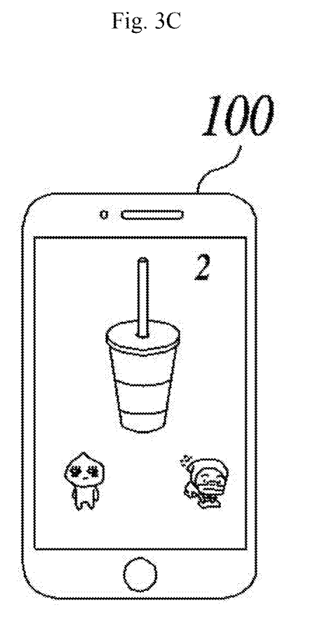

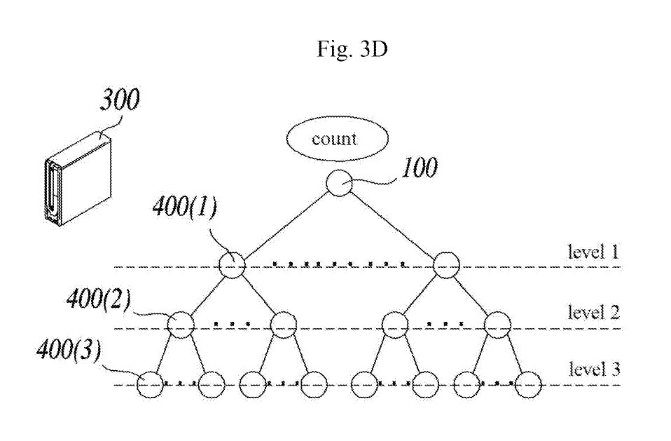

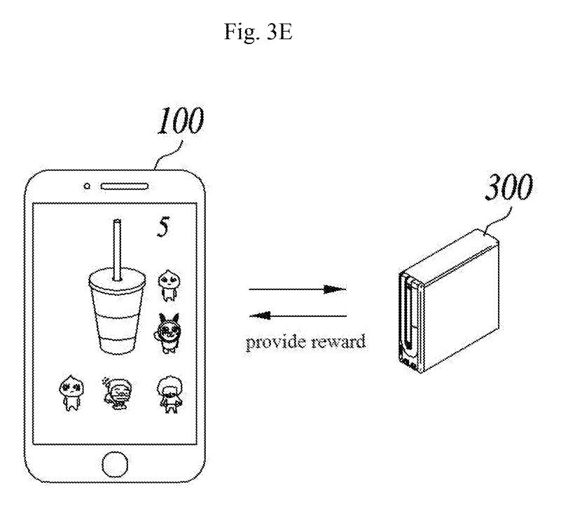

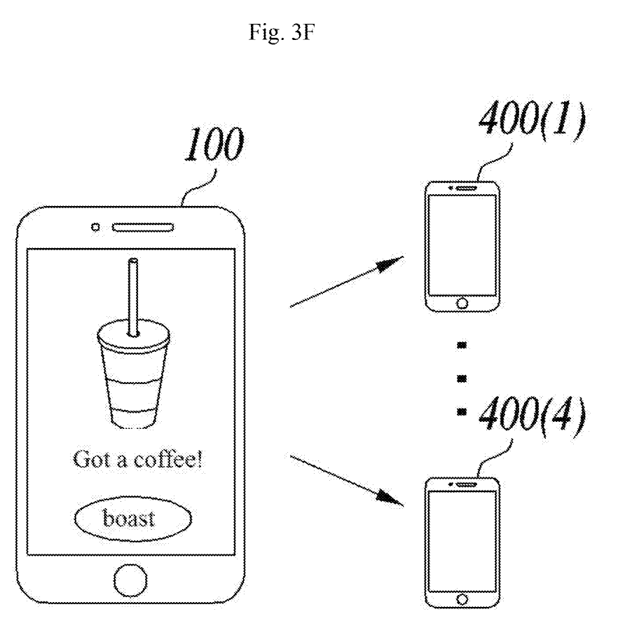

FIG. 2 is a block diagram illustrating a configuration of an advertisement serving server included in the advertisement serving system of FIG. 1. FIG. 3 is a view illustrating an advertisement service that provides a reward depending on an accrued scan count using virtual content in an AR and VR environment according to an embodiment.

Referring to FIG. 2, the advertisement serving server 300 may include a requesting unit 310, a providing unit 320, an accruing unit 330, a leveling unit 340, a rewarding unit 350, a social network service (SNS) interworking unit 360, a reward notifying unit 370.

According to an embodiment, the requesting unit 310, the providing unit 320, the accruing unit 330, the leveling unit 340, the rewarding unit 350, the SNS interworking unit 360, and the reward notifying unit 370 may be implemented as their respective processors (not shown). Alternatively, the operations and functions of the requesting unit 310, the providing unit 320, the accruing unit 330, the leveling unit 340, the rewarding unit 350, the SNS interworking unit 360 and the reward notifying unit 370 set forth below may be performed or achieved by a processor (not shown) positioned inside or outside the advertisement serving server 300 and connected to the requesting unit 310, the providing unit 320, the accruing unit 330, the leveling unit 340, the rewarding unit 350, the SNS interworking unit 360, and the reward notifying unit 370.

When the advertisement serving server 300 or another server (not shown) that interworks with the advertisement serving server 300 provides the first scanning terminal 100, the second scanning terminal 400(1), or the Nth scanning terminal 400(n) with an advertisement service application, program, app page, or webpage to provide a reward depending on an accrued scan count using virtual content in an AR and VR environment, the first scanning terminal 100, the second scanning terminal 400(1), or the Nth scanning terminal 400(n) may install or open the advertisement service application, program, app page, or webpage. Or, the service program may run on the first scanning terminal 100, the second scanning terminal 400(1), or the Nth scanning terminal 400(n) using a script executed on a web browser. The term “web browser” as used herein may refer to a program enabling use of worldwide web (WWW) services, which receives and shows hypertext created in hypertext mark-up language (HTML), examples of which may include Netscape, Internet Explorer, or Chrome.

The term “application” as used herein may refer to an application program running on the terminal, examples of which may include apps running on mobile terminals (e.g., smartphones).

According to an embodiment, the virtual content may include virtual reality (VR) content or augmented reality (AR) content. AR is technology that may mix real life with a virtual environment seamlessly and in real-time and provide the result to the user, allowing the user more immersive and real-life experiences. AR may be somewhere between VR and those shown on TV and this technology is also based on virtuality as is VR. A difference between VR and AR lies in the degree of approaching the real world. VR provides only virtual objects in an artificially created virtual environment whereas AR mixes virtual objects into the real world environment.

In sum, AR may be said to have branched from VR, merging a virtual environment into a real-world environment. In other words, AR may show virtual objects, which are created on computer, on the real-world background and interwork with the user, allowing the user to experience various virtual, digital information on real-world background as if it is real. Embodiments of the disclosure may take advantage of numerous VR or AR items separately or in combination, without being limited in type.

Referring to FIG. 2, the first scanning terminal 100 may capture a product for advertisement and send a request for virtual content corresponding to the product to the requesting unit 310.

For example, assuming that the product for advertisement is a cup of coffee, the first scanning terminal 100 may capture the cup of coffee and send a request for virtual content corresponding to the cup of coffee to the requesting unit 310. The requesting unit 310 may search for a virtual item corresponding to the image of the cup of coffee. The requesting unit 310 may also recognize an AR or VR mark printed on the coffee cup and may search AR content or VR content which has previously been mapped to the AR or VR mark and stored. The virtual content, as set forth above, may include content including a plurality of AR items or VR items or combinations thereof. The requesting unit 310 may recognize the coffee brand by objection recognition or optical character recognition (OCR).

The providing unit 320 may provide the virtual content corresponding to the advertisement product to the first scanning terminal 100. The virtual content may include a plurality of items. The number of items to be activated or unlocked may increase as the number of terminals scanning or capturing the screen of the first scanning terminal 100 increases.

For example, assuming that girl band Z consists of members A, B, C, and D and that AR content for one of the members is one item, a fan of girl band Z would desire to allow all of the members A through D to be shown on the screen. In this case, where only content A shows up when the first scanning terminal 100 first scans the advertisement product, more virtual contents B, C, and D may sequentially show up on the screen as more people scan the first scanning terminal 100 (e.g., as more people view the advertisement content). For example, if only member A dances when the first scanning terminal 100 scans, then all of the members A, B, C, and D may show up as dancing on the screen when the other three are scanned.

Accordingly, the user of the first scanning terminal 100 may encourage the terminal, which has scanned the screen of the first scanning terminal 100, to be scanned on another terminal, thereby allowing customers to attend the advertisement.

The accruing unit 330 may count the second scanning terminal 400(1) as a first accrued terminal when the second scanning terminal 400(1) captures the virtual content displayed on the first scanning terminal 100. Upon counting the second scanning terminal 400(1) as the first accrued terminal when the second scanning terminal 400(1) captures the virtual content displayed on the first scanning terminal 100, a swipe pattern may be created corresponding to a gesture of sending the displayed virtual content in the direction from the first scanning terminal 100 to the second scanning terminal 400(1).

Thus, the accruing unit 330 may detect the position of the swipe pattern in the first scanning terminal 100 and the direction of the swipe pattern and may provide such an image as if the virtual content moves to the second scanning terminal 400(1). The moving speed, direction, and angle of the virtual content in the screen may be controlled corresponding to the speed, direction, and angle of the swipe pattern.

For example, person B may scan person A's terminal while they face each other, or to add fun, such a gesture as if AR content is directly given may also be used. For example, assuming that the advertisement product is a detergent and an AR content for the detergent is output on the detergent container, such a series of animation effects as if the AR content moves from person A's terminal to B's terminal may be provided when person A makes a gesture of giving the AR content to B or swipes the AR content towards B. By doing so, the AR content may move from A to B, and upon being in B's terminal, the AR content is not shown in A's terminal. This may provide such an animation effect as if a real-world product is moves from A to B. Alternatively, the AR content may be left both in A's and B's terminal even though it is moved from A to B.

User-to-AR content interaction is a critical element in AR. Such interactions can be achieved by direct manipulation on keyboard, mouse, or joystick, touch and entry on touchscreen, or recognizing and tracing hand posture and movement and entry of commands.

In controlling AR applications created for use on smartphone, two degree of freedom systems, such as those of mice or touchscreens, might not properly represent three degree of freedom systems and are thus ineffective. In this case, a method that may be taken into consideration may be to differentiate gestures for objects inside and out and approach the inside object using a long touch gesture as mentioned above. In addition, since use of a hand gesture allows for delivery of such information as a three-dimensional (3D) space or shape—thus, interaction with a 3D object may be implemented more naturally and intuitively, such a method as using gestures as well as patterns may be used as well.

In other words, the accruing unit 330 may use the wearable device of the first scanning terminal 100, e.g., a sensor of an armband or smartwatch. Since practicability and user convenience are also critical in determining how to implement a user interface, and gesture needs to be recognized well anywhere in 3D space, e.g., a wearable armband may be put to use when it interworks with the first scanning terminal 100.

Upon counting the second scanning terminal 400(1) as the first accrued terminal when the second scanning terminal 400(1) captures virtual content displayed on the first scanning terminal 100, the accruing unit 330 may display the number, i.e., 1, of the first accrued terminal on the first scanning terminal 100. Where the terminal capturing the screen of the second scanning terminal 400(1) builds up a branch to allow the binary tree to stretch downwards with nodes, the number “1” of the first scanning terminal 100 may be varied in real-time to increase.

Where the terminal capturing the screen of the second scanning terminal 400(1) forms a branch to allow the binary tree to stretch down with nodes, the accruing unit 330 may change, in real-time, the numbers of the nodes corresponding to the first scanning terminal 100, second scanning terminal 400(1), and the terminal positioned at the lower node. This may provide the user with a real-time indication as to how many people have scanned and how many people remain to the reward, as well as how many people are included in the tree.

Where the terminal capturing the screen of the second scanning terminal 400(1) builds up a branch to allow the binary node to stretch down with nodes, the leveling unit 340 may count the level corresponding to the depth of the node. For example, the second scanning terminal 400(1) may belong to the first level nodes which have the first scanning terminal 100 as an upper node (e.g., a parent node), and the number of branches between the first scanning terminal 100 and the second scanning terminal 400(1) may be 2. In this case, if a third scanning terminal 400(2) scans the screen of the second scanning terminal 400(1), the number of branches between the first scanning terminal 100 and the third scanning terminal 400(2) may be 2 and the third scanning terminal 400(2) may be at the node level of 2. Likewise, the number of branches between the first scanning terminal 100 and the Nth scanning terminal 400(n) may be n−1, and the level of the Nth scanning terminal 400(n) may be n. Accordingly, as the Nth scanning terminal 400(n) scans, the level that the first scanning terminal 100 happens to have may be n.

Where the node level reaches a preset number, the rewarding unit 350 may provide a preset reward to the first scanning terminal 100 which has first scanned the advertisement product.

For example, if the advertisement product is a detergent and there is an event that the detergent is provided as a reward when 10 scans are achieved, then a coupon for the detergent may be provided to the first scanning terminal 100 when the level counted reaches 10 (i.e., 10 people scan).

A pre-stored identifier may be created and output as an icon on the screen of the first scanning terminal 100 to allow the first scanning terminal to be identified. This may be for identifying the first scanning terminal. The identifier may be created as, e.g., an exclamation mark or question mark, or other text or image, or video.

Where the node level reaches a preset number, the rewarding unit 350 may provide a preset reward to the first scanning terminal 100 that has first scanned the advertisement product, and then, the SNS interworking unit 360 may provide user information about the plurality of scanning terminals forming the nodes of the binary tree to the preset number of level to a social media account of the first scanning terminal 100. According to the six degrees of Kevin Bacon which posits any two people on Earth are six or fewer acquaintance links apart, and based on the fact that the branches of the scanning persons increase, the profile information about the scanning persons may be provided to the first scanning terminal 100 and each node-corresponding terminal in the binary tree on their owned social media accounts. By scanning each other, they may advertise themselves and do social activities while having fun.

Where the node level reaches a preset number, the rewarding unit 350 may provide a preset reward to the first scanning terminal 100 that has first scanned the advertisement product, and then, when the first scanning terminal 100 uses the reward, the reward notifying unit 370 may drive a camera of the first scanning terminal 100 to capture an image. The reward notifying unit 370 may stream the captured image to the plurality of scanning terminals that constitute as many nodes of the binary tree as the preset number of level. Accordingly, the user of the first scanning terminal 100, who wins a prize or receives the reward, may be streamed to, and output by, each of the terminals at the nodes so that the users of the terminals may be motivated and prompted to encourage others to branch out from themselves. As such, the number of branches may drastically increase as customers voluntarily attend.

Turning back to the example of the girl band, the virtual content may include a plurality of locked items, and as more and more terminals capture the first scanning terminal 100 or the second scanning terminal 400(1), the type and number of locked items which are unlocked and displayed in a preset order may increase. Thus, customers may voluntarily attempt to scan to increase the scan count so as to obtain their desired items or AR emoticons, which would increase advertisement effects.

It may be the first scanning terminal 100, in an embodiment, or another in another embodiment, that receives the reward.

A server (e.g., the advertisement serving server 300) for providing an advertisement service to provide a reward depending on an accrued scan count using virtual content in an augmented reality (AR) and virtual reality (VR) environment may comprise a processor (not shown) and a memory (not shown) connected with the processor, wherein the memory stores a program running on a computer, the program including executable instructions configured to, when executed by the processor, enable the processor to receive a request for virtual content corresponding to a product for advertisement from a first scanning terminal capturing the product, provide the virtual content to the first scanning terminal, count a second scanning terminal as a first accrued terminal when the second scanning terminal captures the virtual content displayed on the first scanning terminal, when a third terminal capturing a screen of the second scanning terminal forms a branch to stretch to a lower node in a binary tree, counting a level corresponding to a depth of the node, and when the level reaches a preset number, providing preset reward to any one of the first scanning terminal, the second scanning terminal, and the third terminal.

Operations of the advertisement serving server 300 of FIG. 2 are described below in greater detail with reference to FIG. 3. However, it should be appreciated by one of ordinary skill in the art that the disclosure is not limited to the embodiments set forth herein.

Referring to FIG. 3A, the first scanning terminal 100 captures or scans a product for advertisement and transmits the captured or scanned data to the advertisement serving server 300, and the advertisement serving server 300 receives the captured or scanned data and creates a binary tree having the first scanning terminal 100 as the uppermost node, i.e., a parent node.

Referring to FIG. 3B, where the second scanning terminal 400(1) scans the screen of the first scanning terminal 100, the number of terminals scanning the screen of the first scanning terminal 100, which is displayed on the screen of the first scanning terminal 100, is changed from 1 to 2, and the advertisement serving server 300 positions the second scanning terminal 400(1) at a lower node.

Referring to FIG. 3C, the advertisement serving server 300 may increase the type or number AR or VR contents displayable on the first scanning terminal 100, and the first scanning terminal 100 may display the increased type or number of AR or VR contents.

Referring to FIG. 3D, the advertisement serving server 300 may manage nodes or branches created with respect to the first scanning terminal 100 and manage the number of scanning terminals 400(1) to 400(n) corresponding to the nodes.

Referring to FIG. 3E, when the scan count reaches a preset number, the advertisement serving server 300 may provide a preset reward to the first scanning terminal 100 and increase the type or number of AR or VR contents so that all of the unlocked contents can be output.

Referring to FIG. 3F, where the user of the first scanning terminal 100 receives a cup of coffee in a coffee shop, the first scanning terminal 100 may capture and share the scene with the second scanning terminal 400(1) through the Nth scanning terminal 400(n), thereby motivating the users of the terminals to encourage their friends or acquaintances to scan.

Other examples may be taken as follows, but without limited to: where five users scan the VR screen, a buy-one-get-one free coupon may be provided to user 1 or user 5; where user 1 scans the logo of a product, and three or more other users scan the VR screen of user 1's terminal, users 1, 2, and 3 may be allowed to view a famous chef's recipe using the product; and family restaurant A associates the service of the disclosure with a location-based service to let its eastern branch provide a 10% discount coupon to a group of six or more persons while letting its western branch provide a 20% discount coupon to a group of five or more persons.

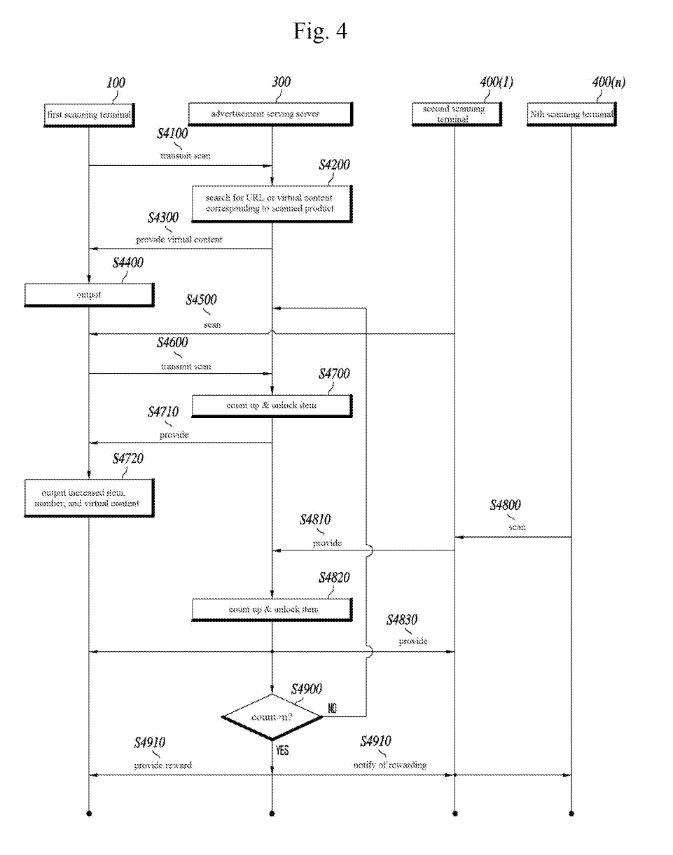

FIG. 4 is a view illustrating a process for transmitting and receiving data among components of an advertisement serving system as illustrated in FIG. 1, according to an embodiment.

Now described with reference to FIG. 4 is an example process of transmitting and receiving data among the components of the advertisement serving system, but it should be appreciated by one of ordinary skill in the art that the disclosure is not limited thereto but various changes may be made thereto according to the embodiments set forth above.

Referring to FIG. 4, the advertisement serving server 300 receives a screen scanned or captured by the first scanning terminal 100 from the first scanning terminal 100 (S4100) and searches for a uniform resource locator (URL) or virtual content corresponding to the scanned product (S4200).

The advertisement serving server 300 provides the virtual content to the first scanning terminal 100, and when the first scanning terminal 100 outputs the virtual content, the advertisement serving server 300 enables the first scanning terminal 100 to output AR or VR content (S4400).

Where the second scanning terminal 400(1) scans the screen of the first scanning terminal 100 (S4500), the advertisement serving server 300 receives the scanning event from the first scanning terminal 100 (S4600), increases the scan count, and starts to unlock items (S4700).

The unlocked items are transmitted from the advertisement serving server 300 to the first scanning terminal 100 (S4710), and the increased items, the counted number, and the virtual content may be provided from the first scanning terminal 100 (S4720).

Where the Nth scanning terminal 400(n) scans the screen of the second scanning terminal 400(1) (S4800), the second scanning terminal 400(1) transmits the scanning event to the advertisement serving server 300 (S4810), and the advertisement serving server 300 creates a binary tree having the second scanning terminal 400(1) as the uppermost parent node while simultaneously increasing the scan count of the first scanning terminal 100 and unlock and provides more items (S4820 and S4930).

The advertisement serving server 300 determines whether the counted number reaches a preset number n (S4900). When the counted number reaches the preset number n, the advertisement serving server 300 may provide a reward to the first scanning terminal 100 and provide the second scanning terminal 400(1) through the Nth scanning terminal 400(n) with a notification indicating that the reward has been provided to the first scanning terminal 100 (S4910).

The order of the above-described steps S4100 to S4910 is merely an example, and embodiments of the disclosure are not limited thereto. For example, steps S4100 to S4910 may be performed in a different order or some of the steps may simultaneously be performed or omitted.

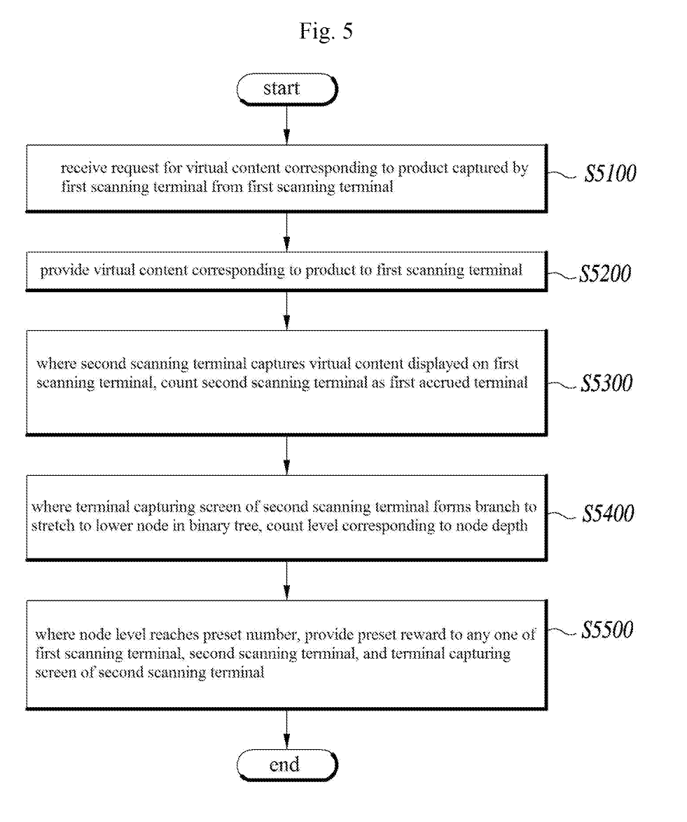

FIG. 5 is a flowchart illustrating an advertisement serving method that provides a reward depending on an accrued scan count using virtual content in an AR and VR environment, according to an embodiment.

Referring to FIG. 5, the first scanning terminal captures a product of advertisement, and the advertisement serving server receives a request for virtual content corresponding to the advertisement product from the first scanning terminal (S5100).

The advertisement serving server provides virtual content corresponding to the advertisement product to the first scanning terminal (S5200), and when the second scanning terminal captures the virtual content displayed on the first scanning terminal, the advertisement serving server counts the second scanning terminal as a first accrued terminal (S5300).

Where a terminal capturing the screen of the second scanning terminal builds up a branch for stretching downward the binary tree with nodes, the advertisement serving server counts the level corresponding to the node depth (S5400), and where the node level reaches a preset number, the advertisement serving server provides a preset reward to any one of the first scanning terminal, which has first scanned the advertisement product, the second scanning terminal, and the terminal capturing the screen of the second scanning terminal (S5500).

The advertisement serving method to provide a reward depending on an accrued scan count using virtual content in an AR and VR environment, according to an embodiment, described with reference to FIG. 5 may be implemented in the form of a recording medium or computer-readable medium containing computer-executable instructions or commands, such as an application or program module executable on a computer.

The computer-readable medium may be an available medium that is accessible by a computer. The computer-readable storage medium may include a volatile medium, a non-volatile medium, a separable medium, and/or an inseparable medium.

The computer-readable medium may include a computer storage medium.

The computer storage medium may include a volatile medium, a non-volatile medium, a separable medium, and/or an inseparable medium that is implemented in any method or scheme to store computer-readable commands, data architecture, program modules, or other data or information.

According to an embodiment, the above-described advertisement serving method to provide a reward depending on an accrued scan count using virtual content in an AR and VR environment may be executed by an application installed on a terminal, including a platform equipped in the terminal or a program included in the operating system of the terminal), or may be executed by an application (or program) installed by the user on a master terminal via an application providing server, such as a web server, associated with the service or method, an application, or an application store server.

Various embodiments as set forth herein may be implemented as software (e.g., a computer program or application) containing instructions that are stored in a machine (e.g., computer)-readable storage medium (e.g., a memory) or an external memory. The machine may be a device that may invoke an instruction stored in the storage medium and may be operated as per the invoked instruction. The machine may include an electronic device (e.g., the advertisement serving server 300) according to embodiments disclosed herein. When the instruction is executed by a processor included in, or provided separately from, e.g., the advertisement serving server 300, the processor may perform a function corresponding to the instruction on its own or using other components under the control of the processor. The instruction may contain a code that is generated or executed by a compiler or an interpreter. The machine-readable storage medium may be provided in the form of a non-transitory storage medium. Here, the term “non-transitory” simply means that the storage medium does not include a signal and is tangible, but this term does not differentiate between where data is semipermanently stored in the storage medium and where data is temporarily stored in the storage medium.

According to an embodiment, there may be provided a computer readable recording medium, e.g., a memory, storing a program running on a computer, the program including executable instructions configured to, when executed by a processor, enable the processor to receive a request for virtual content corresponding to a product for advertisement from a first scanning terminal capturing the product, provide the virtual content to the first scanning terminal, count a second scanning terminal as a first accrued terminal when the second scanning terminal captures the virtual content displayed on the first scanning terminal, when a third terminal capturing a screen of the second scanning terminal forms a branch to stretch to a lower node in a binary tree, counting a level corresponding to a depth of the node, and when the level reaches a preset number, providing preset reward to any one of the first scanning terminal, the second scanning terminal, and the third terminal.

According to an embodiment, the above-described advertisement serving method to provide a reward depending on an accrued scan count using virtual content in an AR and VR environment may be implemented in an application or program installed as default on the terminal or installed directly by the user and may be recorded in a recording medium or storage medium readable by a terminal or computer.

According to various embodiments of the disclosure, lifelike information may be provided through three-dimensional (3D) objects that support various senses, e.g., sight, hearing, and touch, and intuitive interactions allow users to maximally be immersive.

Whenever each branch forms, the scan count is provided to the first scanning user, and when the scan count reaches a preset number, a reward may be provided to the user. Further, whenever a branch is added, more virtual contents can be unlocked. This may lead customers to actively and voluntarily attend the advertisement activity.

Although embodiments of the disclosure have been described with reference to the accompanying drawings. It will be appreciated by one of ordinary skill in the art that the disclosure may be implemented in other various specific forms without changing the essence or technical spirit of the disclosure.

Thus, it should be noted that the above-described embodiments are provided as examples and should not be interpreted as limiting.

Each of the components may be separated into two or more units or modules to perform its function(s) or operation(s), and two or more of the components may be integrated into a single unit or module to perform their functions or operations.

It should be noted that the scope of the disclosure is defined by the appended claims rather than the described description of the embodiments and include all modifications or changes made to the claims or equivalents of the claims.

What is claimed is:

1. A method for providing an advertisement service to provide a reward depending on an accrued scan count using virtual content in an augmented reality (AR) and virtual reality (VR) environment, the method executed on an advertisement serving server and comprising:
receiving a request for virtual content corresponding to a product for advertisement from a first scanning terminal capturing the product;
providing the virtual content to the first scanning terminal;
counting a second scanning terminal as a first accrued terminal when the second scanning terminal captures the virtual content displayed on the first scanning terminal;
when a third terminal capturing a screen of the second scanning terminal forms a branch to stretch to a lower node in a binary tree, counting a level corresponding to a depth of the node; and
when the level reaches a preset number, providing preset reward to any one of the first scanning terminal, the second scanning terminal, and the third terminal.

2. The method of claim 1, wherein a pre-stored identifier configured to identify the first scanning terminal is created and output as an icon.

3. The method of claim 1, further comprising, after providing the preset reward, providing user information about a plurality of scanning terminals constituting nodes of the binary tree up to the preset number of level to a social media account of the first scanning terminal.

4. The method of claim 1, further comprising, after providing the preset reward:
driving a camera of the first scanning terminal to capture an image when the first scanning terminal uses the reward; and
streaming the captured image to a plurality of scanning terminals constituting nodes of the binary tree up to the preset number.

5. The method of claim 1, wherein the virtual content includes VR content or AR content.

6. The method of claim 1, wherein counting the second scanning terminal as the first accrued terminal when the second scanning terminal captures the virtual content displayed on the first scanning terminal includes:
creating a swipe pattern corresponding to a gesture of sending the displayed virtual content in a direction from the first scanning terminal to the second scanning terminal;
detecting a position of the swipe pattern on the first scanning terminal and the direction of the swipe pattern; and
providing an image of movement of the virtual content to the second scanning terminal, and wherein a moving speed, moving direction, and moving angle of the virtual content on screen are controlled corresponding to a speed, direction, and angle of the swipe pattern.

7. The method of claim 1, wherein counting the second scanning terminal as the first accrued terminal when the second scanning terminal captures the virtual content displayed on the first scanning terminal includes displaying a number of the first accrued terminal, which is 1, on the first scanning terminal, and wherein when the third terminal forms the branch to stretch to the lower node in the binary tree, the number of the first accrued terminal is varied in real-time to increase.

8. The method of claim 7, wherein when the third terminal forms the branch to stretch to the lower node in the binary tree, the number corresponding to the node level is varied in real-time to the first scanning terminal, the second scanning terminal, and a terminal positioned at the lower node.

9. The method of claim 1, wherein the virtual content includes a plurality of locked items, and wherein as terminals capturing the first scanning terminal or the second scanning terminal increase in number, the plurality of locked items are unlocked and displayed in a preset order.

10. A storage medium storing an application configured to execute the method of claim 1.

11. A server for providing an advertisement service to provide a reward depending on an accrued scan count using virtual content in an augmented reality (AR) and virtual reality (VR) environment, the system comprising:
a processor; and
a memory connected with the processor, wherein the memory stores a program running on a computer, the program including executable instructions configured to, when executed by the processor, enable the processor to receive a request for virtual content corresponding to a product for advertisement from a first scanning terminal capturing the product, provide the virtual content to the first scanning terminal, count a second scanning terminal as a first accrued terminal when the second scanning terminal captures the virtual content displayed on the first scanning terminal, when a third terminal capturing a screen of the second scanning terminal forms a branch to stretch to a lower node in a binary tree, counting a level corresponding to a depth of the node, and when the level reaches a preset number, providing preset reward to any one of the first scanning terminal, the second scanning terminal, and the third terminal.
